(19) United States
(12) Patent Application Publication
(10) Pub. No.: US 2025/0058335 A1
(43) Pub. Date: Feb. 20, 2025

(54) DEVICE FOR DELIVERING AN ORBITAL FLUID JET

(71) Applicants: Nicolas GANSHOF VAN DER MEERSCH, Vufflens-le-Chateau (CH); Kaddour RAISSI, Paris (FR)

(72) Inventors: Nicolas GANSHOF VAN DER MEERSCH, Vufflens-le-Chateau (CH); Kaddour RAISSI, Paris (FR)

(21) Appl. No.: 18/722,287

(22) PCT Filed: Dec. 21, 2022
(86) PCT No.: PCT/EP2022/087220

§ 371 Date: Jun. 20, 2024

(30) Foreign Application Priority Data
Dec. 23, 2021 (GB) 2118899.0

(51) Int. Cl. B05B 3/06; B05B 1/18; B05B 3/04

(52) U.S. Cl. CPC B05B 3/06; B05B 1/18; B05B 3/0486

(57) ABSTRACT

1 A device (1) for delivering an orbital fluid jet, comprising a body comprising a pressure chamber (3) provided with a fluid inlet and a fluid outlet (7), a rotor (1) having a top, a bottom, a rotational axis (15), and a fluid channel (C_{PQ}) having a fluid inlet (E_{P}) located on the top of the rotor on the axis (15) for receipt of fluid from the fluid outlet (7) of the body, an outlet (S_{PQ}) located on the bottom of the rotor (1) spaced from the axis (15), and a helical channel providing fluid communication between the inlet and exit configured to cause the rotor to rotate about the axis (15) when fluid is forced through the channel, and a mounting for rotatably mounting the rotor (1). The mounting is disposed within the pressure chamber (3), and the rotor (1) comprises an axle (10) that extends through the fluid outlet (7) of the pressure chamber (3), wherein the axle is suspended from the mounting for rotation relative to the mounting about the rotational axis (15). The mounting comprises a socket (13) with a central aperture (14), and in which the axle (10) extends through the central aperture and comprises a ball (11) configured to nest in the socket (13) for rotation of the ball and axle relative to the socket.

### FIELD OF THE INVENTION

The present invention relates to a device for delivering an orbital fluid jet, and a fluidic projection device comprising a device for delivering an orbital fluid jet, such as a shower head.

### BACKGROUND TO THE INVENTION

There are various fluidic projection devices, single-jet or multi-jet, orbital or non-orbital jet, loaded or not with particles, such as shower heads, guns, hoses) and projection nozzles. Orbital jet devices implement an orbital jet producing an annular impact allowing: (i) to treat larger surfaces and (ii) to have more energetic and effective impacts on the target. These orbital jet devices have interesting technical performance and operating costs.

The fluidic projection device, according to the document bearing the reference FR2934508 A1 (RAISSI KADDOUR [FR]), implements several orbital jets at once, thus increasing the processing performance. These orbital jets are configured according to the solution of the FIG. 4: The jets expelled by the orifices (O_{P}) flow into channels that extend through the rotors (R_{P}) from an inlet (E_{P}) at the top to an outlet (S_{PQ}) at the bottom. The channels are configured to effect rotation of the rotor under the effect of the flow through the channel (e.g. the channel takes a helical path through the rotor). The rotors are mounted on bearings disposed along each side of the rotor.

However, given the conditions of its use in an aggressive and unclean environment, in which it is exposed to fluidic flows often loaded with particles, this device is faced with problems of fouling and friction at the level of the rotating parts. Deposits of scale and corrosion appear on the bearing surfaces causing friction and resistance to the pivoting of said rotors. The use of sealed bearings does not improve the situation, as the friction generated by the flanges strongly disturbs the rotation of the rotor (R_{P}).

The systematic fouling of the roller or friction bearings, causes friction that blocks the rotation of the rotors, and makes the device unreliable and non-robust, preventing any possibility of industrial exploitation and closing the doors of the markets.

It is an objective of the invention to overcome at least one of the above-referenced problems.

### SUMMARY OF THE INVENTION

The objective is met by the provision of a device for delivering an orbital fluid jet that is similar to the device of FR2934508 A1. However, unlike the device of FR2934508 A1 in which the mounting is a bearing that embraces an axle of the rotor, the present invention is characterised by suspending the rotor using a ball and socket type bearing arrangement in which the mounting comprises a socket and the rotor comprises a ball configured to nest within the socket where the socket supports the weight of the rotor and allows rotation of the ball/axle/rotor relative to the socket. This embodiment is illustrated in FIGS. 20 and 21.

In a first aspect, the invention provides a device for delivering an orbital fluid jet, comprising:
a body comprising a pressure chamber provided with a fluid inlet and a fluid outlet;
a rotor having a top, a bottom, a rotational axis, and a fluid channel having a fluid inlet located on the top of the rotor on the axis for receipt of fluid from the fluid outlet of the body, an outlet located on the bottom of the rotor spaced from the axis), and a helical channel providing fluid communication between the inlet and exit configured to cause the rotor to rotate about the axis when fluid is forced through the channel; and
a mounting for rotatably mounting the rotor.

The device of the invention is characterised in that the mounting is disposed within the pressure chamber, and the rotor comprises an axle that extends through the fluid outlet of the pressure chamber, wherein the axle is suspended from the mounting for rotation relative to the mounting about the rotational axis.

In any embodiment, the mounting comprises a socket with a central aperture, and in which the axle extends through the central aperture and comprises a ball mounted around the axle configured to nest in the socket for rotation of the ball and axle relative to the socket.

The socket is generally concave and in one embodiment comprises a hemi-spherical depression. However, it may also comprise a conical or frustum shaped depression.

In any embodiment, the ball is spherical. In other embodiment, the ball may be hemi-spherical or comprise a hemi-spherical base. In other embodiment, the ball has a convex base.

In any embodiment, a bearing surface of the mounting comprises a ball bearing or roller bearing.

In any embodiment, the device comprises an axle guide disposed in the pressure chamber between the mounting and the fluid outlet. The axle guide may be for example a bearing that surrounds a section of the axle to limit lateral movement of the axle during rotation about rotational axis (ZP).

In another embodiment, the device of the invention is characterised in that the rotor is provided by a spinning top (T_{P}) having an axis of rotation (Z_{P}) and an axial shaft (A_{P}) located along the axis of rotation (Z_{P}), and the mounting comprises a guide cavity (D_{P}) disposed in the pressure chamber (CH) and a seat cavity (B_{P}), wherein the axial shaft (A_{P}) is mounted for rotation about the axis of rotation (Z_{P}) between the guide cavity and the seat cavity.

The guide cavity and seat cavity are generally configured to allow a degree of play between respective ends of the axial shaft and the bores. Generally, the play includes axial play of the axial shaft relative to the supporting cavities. The play generally also includes a degree of lateral play between one or both ends of the axial shaft and the cavities.

In any embodiment, the helical channel comprises a plurality of sections of straight channel sections connected end to end and deployed in a helical path,

In any embodiment, the helical channel tapers inwardly or outwardly from the inlet to the outlet.

In any embodiment, the rotor (R_{P}) comprises a plurality of channels. The channels typically comprise a common inlet (E_{P}) and upper section and separate channel outlets (S_{P1}, S_{P2} . . . , S_{PQ}) located on lower sections.

In any embodiment, the respective ends of the axial shaft (A_{P}) and the guide cavity and seat cavity (D_{P}, B_{P}) are configured to provide axial and lateral play between the axial shaft and the cavities.

In any embodiment, the respective ends of the axial shaft (A_{P}) and the seat cavity and guide cavity (D_{P}, B_{P}) are configured such that the degree of play between the axial shaft and the guide cavity (D_{P}) is greater than the degree of play between the axial shaft and the seat cavity (B_{P}).

In any embodiment, the or each channel outlet (S_{PQ}) is located at a periphery of the bottom of the rotor (R_{P}).

In any embodiment, the body (K) has an upper section (2) and a lower section (4) coupled to the upper section to form the pressure chamber (CH), in which the lower section comprises a plurality of fluid outlets (O₁, O₂. . . . O_{P}) and a plurality of corresponding rotor-receiving chambers (5), in which the lower section comprises an upright support that projects into the pressure chamber (CH) when the upper section and lower section are coupled together, wherein the plurality of guide cavities (D_{P}) are mounted to the upright support in a spaced-apart relationship.

In any embodiment, the device comprises a first mounting element (3) coupled to the upright support, wherein the plurality of guide cavities (D_{P}) are coupled to the first mounting element (3).

In any embodiment, the lower section (4) of the body (K) comprises a second mounting element (6) coupled to a base of the lower section of the body (K), wherein the plurality of seat cavities (B_{P}) are mounted to the second mounting element.

In any embodiment, the first mounting element (3) and second mounting elements (6) are disposed parallel to each other.

In any embodiment, the first mounting element (3) and/or second mounting elements (6) are provided as spur elements having a central part and a plurality of arms extending radially outwardly of the central part, wherein each arm comprises a cavity disposed on an end thereof. The cavity may be mounted on the arm or formed (e.g. drilled) on the arm.

In any embodiment, the lower section comprises at least three rotor-receiving chambers (5) each containing a rotor (R_{P}).

In any embodiment, the device comprises a handle (1) having a distal end and a through lumen, wherein the distal end of the handle is coupled to the body (K) and the lumen is fluidically coupled to the pressure chamber (CH).

In any embodiment, the seat cavity and guide cavity (D_{P} and B_{P}) are bowl shaped.

In any embodiment, the bowl-shaped cavities (D_{P} and B_{P}) are concave or funnel shaped.

In any embodiment, the rotor has fully or partly cylindrical shape. In any embodiment, the rotor has a frustoconical shape.

In any embodiment, each end of the axial shaft (A_{P}) tapers inwardly to an axial tip. The tip may be for example funnel shaped or convex in shape.

In another aspect, the invention provides a fluid projection device comprising one or more devices according to the invention.

The device according to the invention makes it possible to remedy the problems presented above by proposing a new reliable and robust solution to produce orbital jets, even in the presence of fluids charged or not with particles and despite the fouling of the rotating parts by deposits such as scale, for example. Thus, new perspectives and opportunities for industrial exploitation of the device according to the invention become possible.

This device offers a new solution to produce orbital jets without roller or friction bearings, bearings considered very sensitive to fouling in an aggressive and non-clean environment. This new solution is inspired by the example of the spinning top that rotates on its tip around its axis of rotation until the friction, which very low, stops the rotation.

Thus, the device according to the invention is provided with “P” tops (T_{P}) with a particular geometry because each having a lower tip and an upper tip, [FIG. 5]. These two tips are inserted into two cavities: (i) a lower cavity, called “seat cavity (B_{P})”, receiving the lower tip of the axial shaft and serving as a rotational support for the spinning top (T_{P}) and (ii) an upper cavity called “guide cavity (D_{P})”, located in the pressure chamber (CH) upstream of the orifice (O_{P}), receiving the upper tip of the axial shaft to guide the spinning top and prohibit any interference between said spinning top (T_{P}) in rotation and the device, [FIG. 12]. The seat cavity (B_{P}) must be as thin as possible to avoid alteration of the orbital jets (OJ_{PQ}) after exiting the rotor (S_{PQ}). The mounting and positioning of each spinning top (T_{P}) between the seat cavity (B_{P}) and the guide cavity (D_{P}) is configured to provide play, for example lateral and axial clearance (J1, J2, J3), as shown in [FIG. 12]. Each spinning top (T_{P}) is composed of a rotor (R_{P}) embedded on a shaft (A_{P}) so that their respective axes (e.g. the axis of the spinning top and the axis of the axial shaft) are coincident, [FIG. 11]. Each spinning top (T_{P}) has an annular inlet (E_{P}) centered around the shaft (A_{P}), which gives access to the channels (C_{PQ}) provided on the rotor (R_{P}) [FIG. 15], [FIG. 16], [FIG. 17], [FIG. 18] and [FIG. 19].

The device according to the invention, presented above, works as follows, [FIG. 5]: The fluid or fluids (that may or may not be charged with particles) arrive in the chamber (CH) and are expelled through the annular spaces between the orifices (O_{P}) and the shafts (A_{P}) in the form of annular jets (JA_{P}), flowing around shafts (A_{P}) to the fluidic inlets (E_{P}), to then cross the channels (C_{PQ}) with which the rotors (R_{PQ}) are equipped.

The channels (C_{PQ}) extend from the common inlet (E_{P}) located on the top of each rotor (R_{P}) and centered on the axis (Z_{P}) to separate outlets (S_{PQ}) located at the periphery of the base of the rotor (R_{P}) following a helical trajectory, [FIG. 15] until [FIG. 19], whereby the flow of each annular jet (J_{AP}) in these channels creates a mechanical torque—or moment—with respect to the axis (Z_{P}) which is exerted on the spinning top (T_{P}), causing it to rotate in relation to the seat cavity (B_{P}) and the guide cavity (D_{P}) generating orbital jets (JO_{PQ}) at the exit of the device.

The choice of materials composing the spinning top (T_{P}) as well as the seat cavity (B_{P}) and the guide cavity (D_{P}) typically strongly condition the rotation of said spinning top (T_{P}) and therefore the operation of the device according to the invention. Thus, to guarantee optimal reliability and robustness of this device, these materials preferably must have a good mechanical resistance and oxidation resistance and ensure a good slip and rolling at the level of the contact surfaces between the spinning top (T_{P}), the seat cavity (B_{P}) and the guide cavity (D_{P}).

In summary, the device according to the invention implements a reliable and robust solution to produce “N” orbital jets (OJ_{PQ}), even in the presence of fluids charged or not with particles and despite fouling. The device according to the invention has one or more (“P”) spinning tops (T_{P}), each composed of a rotor (R_{P}) recessed on a shaft (A_{P}). Each spinning top of this device comprises an annular input (E_{P}) feeding into a fluidic channel of helical geometry leading to the output (S_{PQ}) located at the periphery of the base of said rotor (R_{P}). The positioning and holding of each spinning top (T_{P}) are done through the seat cavity (B_{P}) and the guide cavity (D_{P}) where the ends of the axial shaft (A_{P}) are housed.

In any embodiment, the invention provides a device for delivering “N” orbital fluid jets loaded or not loaded with particles, with N≥1, suitable for use in applications such as stripping, sandblasting, polishing, shot blasting, washing-cleaning, massage, scrubbing, drying, watering, painting, and atomizing, comprising: a body (K) having a pressure chamber (CH) equipped with an inlet (E_{F}) of fluid charged or not with particles and “P” orifices (O_{P}), with P≥1, “P” spinning tops (T_{P}), each having an axis of rotation (Z_{P}) and composed of an axial shaft (A_{P}) located along the axis of rotation (Z_{P}), a rotor (R_{P}) with a top and a base and comprising “Q” channels (C_{PQ}), with Q≥1, having:
(i) a shared main inlet (E_{P}) located on the top of the rotor and centered on the axis (Z_{P}) receiving the annular jet (JA_{P}) from the orifice (O_{P}),
(i) (ii) “Q” outputs (S_{PQ}) located on the base of the rotor (R_{P}), distant from the axis (Z_{P}), the “Q” helical channels ensure fluidic communication between the shared input (E_{P}) and the outputs (S_{PQ}), and are configured to rotate the spinning top (T_{P}) around the axis (Z_{P}) when the annular jet (JA_{P}) flows into said channel or channels (C_{PQ}), the device being characterized in that the shaft (A_{P}) is mounted between a guide cavity (D_{P}) located in the pressure chamber (CH) upstream of the orifice (O_{P}) and a seat cavity (B_{P}), to rotate around the axis of rotation (Z_{P}), the connections between the respective ends of the shaft (A_{P}) and the cavities (B_{P}) and (D_{P}) being configured with play.

In any embodiment, each helical channel (C_{PQ}) is composed of several sections of straight ducts connected end to end and deployed following a helical trajectory.

In any embodiment, each helical channel (C_{PQ}) is convergent or divergent.

In any embodiment, the respective ends of the shaft (A_{P}), the seat cavity (B_{P}), and the guide cavity (D_{P}) are configured to ensure axial and radial (lateral) clearances between the upper end of the shaft (A_{P}) and the guide cavity (D_{P}) and a radial clearance between the shaft (A_{P}) and the seat cavity (B_{P}).

In any embodiment, the outputs (S_{PQ}) are located at the periphery of the base of the rotor (R_{P}).

In any embodiment, the body (K) is composed of an upper part comprising a handle (1) provided with an inlet (EF) communicating with the pressure chamber (CH), upper part coupled to a lower part comprising several orifices (O_{P}) and several chambers (5) used to house the spinning tops (T_{P}), and two support parts (3) and (6) on which are mounted the seat cavity (B_{P}) and guide cavity (D_{P}), coupled to the lower part by the screws (9) and positioned angularly by pins (8).

In any embodiment, the seat cavity (B_{P}) and the guide cavity (D_{P}) are concave, for example in the form of a bowl or funnel.

In any embodiment, each end of the shaft (A_{P}) gradually thins to a point on the axis of said shaft (A_{P}).

In any embodiment, each spinning top (T_{P}), guide cavity (D_{P}) and seat cavity (B_{P}) as well as each orifice (O_{P}) are inclined by an angle (β) with respect to the axis (Z_{V}). In any embodiment, the angle β is between 0° and 20°, preferably between 5° and 10°.

In any embodiment, each spinning top (T_{P}) is composed of a rotor (R_{P}) recessed on a shaft (A_{P}) by any suitable means, for example tight adjustment, gluing or obstacle of the screw type.

In any embodiment, inserts (suitably made of materials resistant to wear and oxidation and guaranteeing the necessary sliding and rolling conditions) are integrated into the lower and upper tip of each shaft (A_{P}) as well as each seat cavity (B_{P}) and each guide cavity (D_{P}). Examples of suitably materials include stainless steel, ceramics and some plastics.

In any embodiment, each spinning top (T_{P}) is made in a single piece and includes “Q” Channels (C_{PQ}), having a common inlet (E_{P}) centered around the upper tip located on the axis (Z_{P}), channels (C_{PQ}) which deploy from that entry (E_{P}) up to outputs (SpQ) located on the base of the spinning top (T_{P}) and distant from the axis (Z_{P}), following a helical trajectory, these channels may be convergent or divergent, with circular or non-circular cross-section, comprised of several sections of connected end-to-end straight ducts and deployed along a helical trajectory, or in helical form.

Other aspects and preferred embodiments of the invention are defined and described in the other claims set out below.

### BRIEF DESCRIPTION OF THE FIGURES

FIG. 1 represents a diagram of the device of the invention where the number of spinning tops (T_{P}) “P” is equal to 1.

FIG. 2 represents a diagram of the device of the invention where the number of spinning tops (T_{P}) “P” is greater than 1.

FIG. 3 represents a diagram of the device of the invention delivering orbital jets and/or non-orbital jets.

FIG. 4 (Prior art) represents a diagram of the device of the reference FR2934508 A1.

FIG. 5 represents a diagram of the device of the invention provided with “P” spinning tops (T_{P}).

FIG. 6 represents a diagram of the device of the invention provided with “1” spinning top (T₁).

FIG. 7 represents the overall drawing of a non-limiting configuration of the device of the invention provided with “3” spinning tops (T_{P}).

FIG. 8 represents the overall drawing of a non-exhaustive configuration of the device of the invention wherein the seat cavities (B_{P}), the guide cavities (D_{P}) as well as the orifices (O_{P}) of the spinning tops (T_{P}), are inclined by an angle (β) with respect to the axis (Z_{V}).

FIG. 9 represents a non-limiting example of the axial shaft of a rotor of the device of the invention.

FIG. 10 represents a non-limiting example of the rotor (R_{P}) with a bore (P_{P}) and two channels (Q=2), each composed of two straight duct sections connected end to end.

FIG. 11 represents the rotor (R_{P}) in the form of a spinning top (T_{P}) having an axial shaft (A_{P}).

FIG. 12 represents a diagram of the spinning top (T_{P}) mounted between the seat cavity (B_{P}) and the guide cavity (D_{P}), with mechanical clearance (J1, J2, J3).

FIG. 13 represents examples of possible geometry contacts between (i) the lower tip of the axial shaft (A_{P}) and the seat cavity (B_{P}) and (ii) the upper tip of the axial shaft (A_{P}) and the guide cavity (D_{P}).

FIG. 14 represents a spinning top (T_{P}), a seat cavity (B_{P}) and a guide cavity (D_{P}) with inserts.

FIG. 15 represents an example of a spinning top (T_{P}) with a single channel (Q=1) in helical form.

FIG. 16 represents an example of a spinning top (T_{P}) with two channels (Q=2), in helical form.

FIG. 17 represents an example of a spinning top (T_{P}) provided with a channel (Q=1) composed of two straight sections of conduit connected end to end.

FIG. 18 is an example of a spinning top (T_{P}) with 2 channels (Q=2), each consisting of two straight sections of conduit connected end to end.

FIG. 19 represents an example of the spinning top (T_{P}) provided with 3 channels (Q=3), in helical form.

FIG. 20 is an illustration of an embodiment of a device of the invention, in which the rotor is suspended from a rotor mounting disposed in the pressure chamber by means of a ball and socket bearing arrangement.

FIG. 21 is an illustration of a modified version of the device of FIG. 20, in which the device comprises an axle guide disposed within the pressure chamber in between the mounting and the fluid outlet.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

As used herein, the term “ball and socket

As used herein, the term “spinning top” refers to a rotor having an axis of rotation and an axial shaft that extends proud of each end of the rotor along the axis of rotation of the rotor. The axial shaft may pass through the rotor and generally passes through a centre of gravity of the rotor. The rotor is generally symmetrically arranged around the axial shaft to balance the rotor. The rotor is usually at least partially cylindrical, and may be for example frustoconical in shape.

As used herein, the term “cavity” as used in the terms seat cavity and guide cavity refers to a housing comprising a depression configured to receive an end of the axial shaft. The cavity generally tapers inwardly towards a base thereof, for example funnel or concave shaped, but may also have a base and sidewalls that do not taper inwardly. The purpose of the cavities is to receive and support the ends of the axial shaft allowing the spinning top to spin with minimal friction. The ends of the axial shaft and the cavities are generally configured to allow a degree of play therebetween, preferably both axial and lateral play.

### EXEMPLIFICATION

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

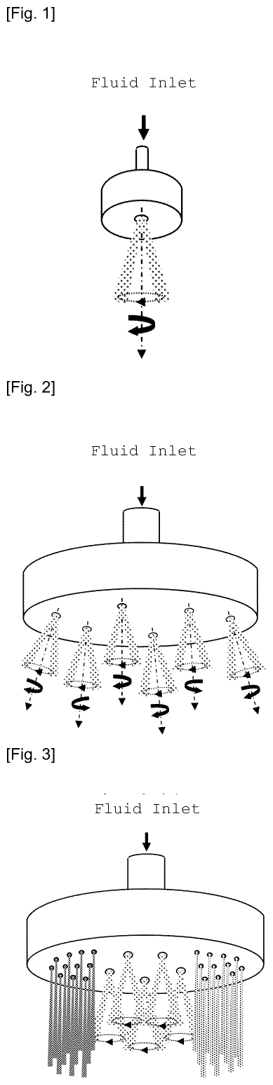

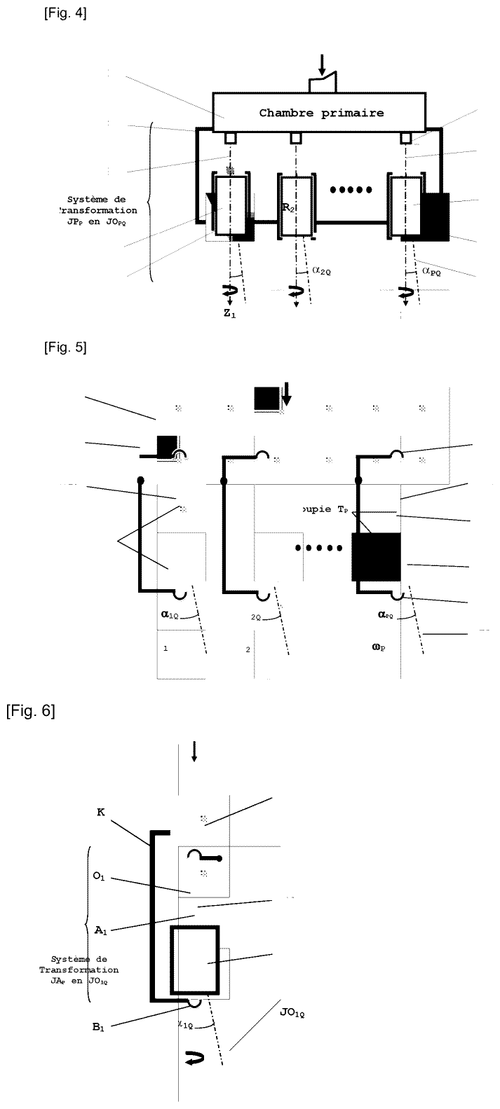

FIGS. 1 to 3, and 5 to 19, describe devices for delivering orbital shower jets. In these devices, the rotor is a spinning top and is mounted between an upper and lower support for rotation under he force of the water passing through the helical channel in the rotor.

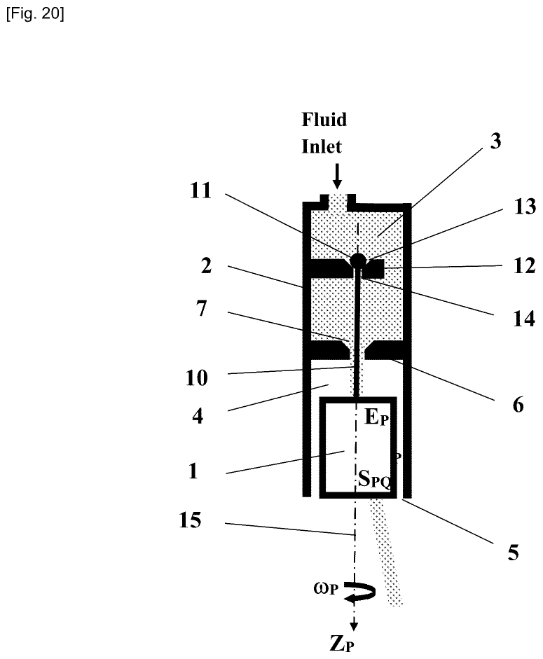

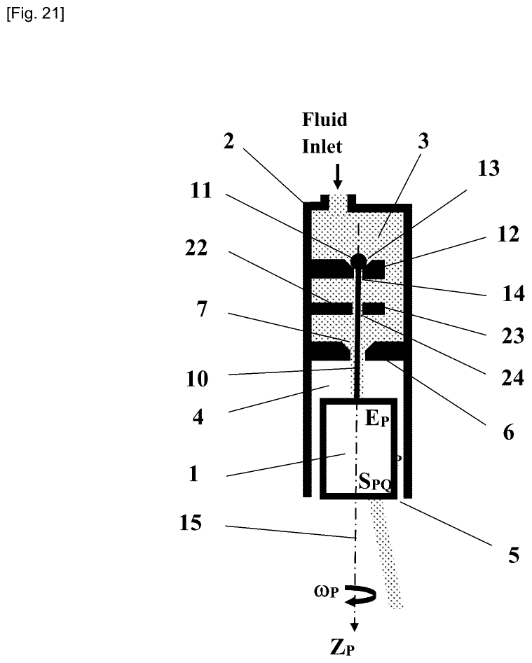

The device of FIGS. 20 and 21 works on the same principle as the devices described with reference to FIGS. 1 to 3 and 5 to 19, but has a different mounting mechanism.

With reference to figures [FIG. 1], [FIG. 2] and [FIG. 3], different versions of the device according to the invention are presented: (i) versions with one or more orbital jets, (ii) version delivering orbital and/or non-orbital jets.

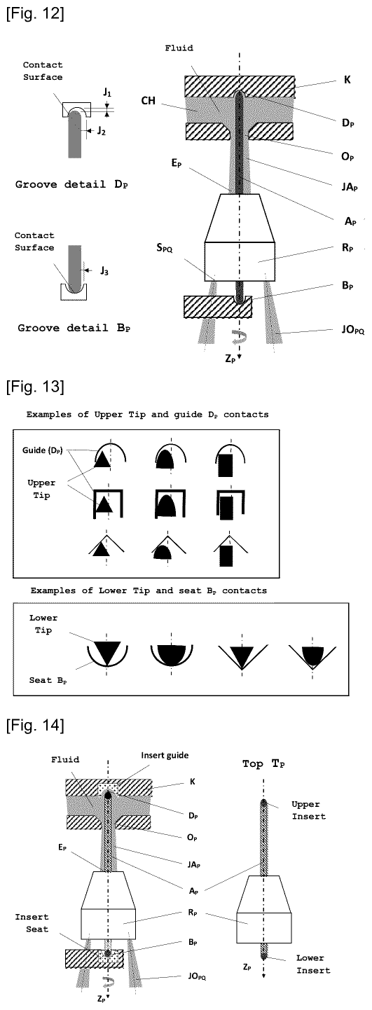

With reference to the figures [FIG. 5] and [FIG. 6], the device according to the invention comprises a body (K), comprising a chamber (CH) provided with a fluid inlet and with “P” orifices (O_{P}). This device also comprises “P” spinning tops (TP), each composed of a rotor (RP) recessed on an axial shaft (A_{P}). The rotor may be attached to the axial shaft by any suitable method, for example by tightening, gluing or by obstacle of the screw type [FIG. 11]. Each spinning top (T_{P}) is mounted between two supports, in this case a seat cavity (B_{P}) and a guide cavity (D_{P}) with axial and lateral clearance (J₁, J₂, J₃), as shown in figure [FIG. 12]. The upper tip is inserted into the guide cavity (D_{P}), located inside the chamber (CH), passing through an orifice (O_{P}). The lower tip of axial shaft (A_{P}) is inserted into the seat cavity (B_{P}) made in the body (K). This seat cavity (B_{P}) plays the role of rotation seat for the lower tip of the axial shaft.

The device according to this particular embodiment of the invention produces “N” orbital jets (OJ_{PQ}) as follows, [FIG. 5]. The fluids arrive through the input (E_{F}) in the pressure chamber (CH) and are, at first, expelled through the annular spaces between the orifices (O_{P}) and shafts (A_{P}) in the form of annular jets (J_{AP}). Each of the annular jets (J_{AP}) flows, guided by the shaft (A_{P}), towards the common inlet (E_{P}) of the rotor (R_{P}) and engages in the channels (C_{PQ}) in the rotor (R_{P}). Given the geometry of said channels, a mechanical moment—or torque—with respect to the axis of rotation (Z_{P}) is exerted on the spinning top (T_{P}). Being mounted between the seat cavity (B_{P}) and guide cavity (D_{P}) with axial and radial clearance (J₁, J₂ and J₃), the spinning top (T_{P}) rotates around the axis of rotation (Z_{P}) producing “N” orbital jets (OJ_{PQ}).

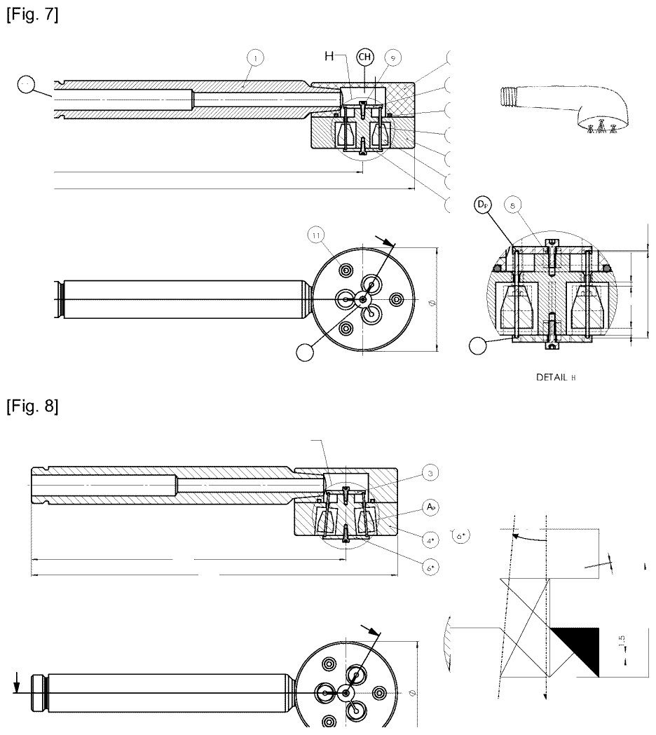

In the embodiment of [FIG. 7], the body (K) consists of an upper section (2) and a lower section (4) and is configured as follows: the device according to the invention comprises a handle (1) provided with an inlet (EF) and recessed in the part (2), itself connected to the part (4) by a system of screws (11). The tightness of the pressure chamber (CH) is ensured by an O-ring (7). Each spinning top (T_{P}), composed of a rotor (R_{P}) and an axial shaft (A_{P}), is housed in a chamber (5) provided in a lower section (4), and mounted between the seat cavity (B_{P}) and guide cavity (D_{P}). The seat cavities (B_{P}) are provided on a second supporting arm (6) which is attached to a base of the lower section (4) by screws. The guide cavities (D_{P}) are provided on a first supporting arm (3) which is mounted by screws to a central column of the lower section (4) that extends into the pressure chamber (CH). Said parts (3) and (6) are positioned angularly by pins (8). Parts (3) and (6) are thin so as to limit interference with orbital jets at the exit of the rotors (R_{P}).

In the embodiment of the [FIG. 8], the spinning tops (T_{P}), the seat cavities (B_{P}) the guide cavities (D_{P}) and the orifices (O_{P}) are inclined by an angle (β) with respect to the axis (Z_{V}). This inclination makes it possible to have a larger surface covered by the impact of orbital jets (OJ_{PQ}).

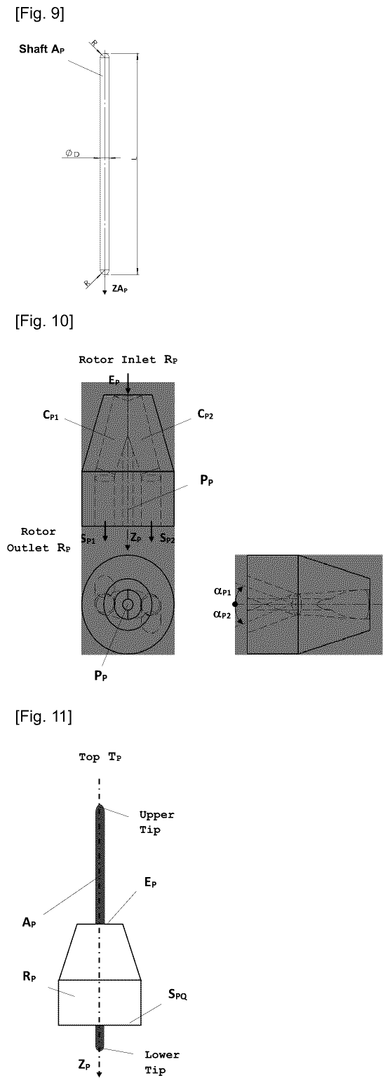

According to the figures [FIG. 9], [FIG. 10] and [FIG. 11], each spinning top (T_{P}) consists of two parts, a shaft (A_{P}) and a rotor (R_{P}), recessed on top of each other, in such a way that the Z_{P} axis of the rotor is coincident with the ZA_{P} axis of the shaft. This recessing can be achieved through a tight fit, gluing, screw type obstacle or other. In another embodiment, each spinning top (T_{P}) can also be made in a single piece by injection, 3D printing or other. These spinning tops (TP) are each mounted between two spin supports—a seat cavity (B_{P}) and a guide cavity (D_{P})—with axial and lateral clearance (J₁, J₂ and J₃), thus ensuring a free rotation around the axis (Z_{P}) [FIG. 12].

The geometries of the two tips of each spinning top (T_{P})—in other words of the two ends of the shaft (A_{P})—, the seat cavity (B_{P}) and the guide cavity (D_{P}) are important for the optimal functioning of the device because they condition the contacts of the tips with the guide cavity (D_{P}) and the seat cavity (B_{P}). These geometries ideally make it possible to: (i) reduce the contact surfaces and consequently reduce the swivel resistance of each spinning top (T_{P}) and (ii) keep in position the tips of said spinning top (T_{P}) in the cavities (B_{P}) and (D_{P}). As a non-limiting example, (i) the seat cavity (B_{P}) and the guide cavity (D_{P}) are concave, in the form of a bowl or funnel, (ii) the contact between the upper tip and the guide cavity (D_{P}) can be of the type “male sphere (convex part)—female sphere (concave part, bowl)” or “male cone—female sphere” and (iii) the contact between the lower tip of the spinning top and the seat cavity (B_{P}) can be of the type “male sphere—female sphere” or “male cone—female sphere”. Some other types of contact are shown in [FIG. 13].

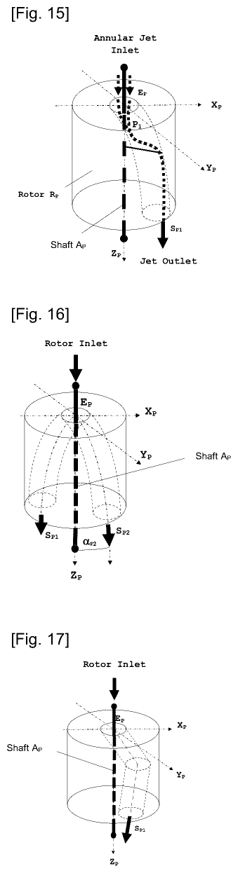

Knowing that each spinning top (T_{P}) is rotating and that its two tips slide and roll in said cavities (B_{P}) and (D_{P}), the materials composing these parts are usually chosen to accommodate these tolerances. Thus, each spinning top (T_{P}), seat cavity (B_{P}) and guide cavity (D_{P}) associated with it, are generally made totally or partially, especially at the level of their contact surface, in suitable materials, resistant to wear and oxidation and guaranteeing the required sliding and rolling conditions. By way of non-limiting example, inserts made of the appropriate materials could be integrated at the contact areas as shown in Figure [FIG. 14] to ensure the proper functioning of the device. In addition, the outputs (S_{PQ}) of the channels (C_{PQ}) can be equipped with anti-limescale pins to limit scaling.

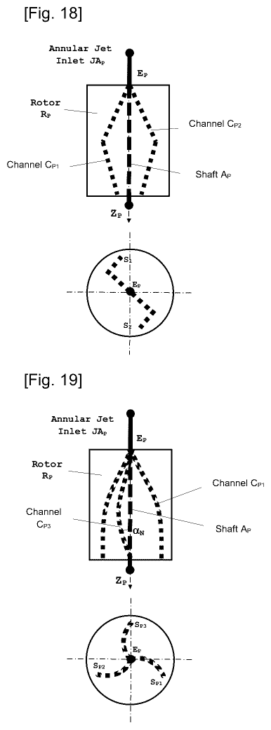

With reference to Figure [FIG. 10], each rotor (R_{P}) has an axial opening hole (P_{P}) used to receive the shaft (A_{P}). This hole can be of circular, square or other cross-section. Each rotor (R_{P}) also has “Q” channels (C_{PQ}) which have a common inlet (E_{P}) located on the top of said rotor (R_{P}) and centered on the axis (Z_{P}) and “Q” outlets (S_{PQ}) located on the periphery of the base of said rotor (R_{P}). These channels (C_{PQ}) extend from the common inlet (E_{P}) to the separate outlets (S_{PQ}) following an a helical trajectory, [FIG. 15], [FIG. 16], [FIG. 17], [FIG. 18] and [FIG. 19]. The geometry of said channels (C_{PQ}) is defined in such a way as to recover part of the kinetic energy of the annular jet (JA_{P}), in order to create a mechanical moment—or torque—with respect to the axis of rotation (ZP).

In the embodiment of the [FIG. 10], the rotor (R_{P}) comprises two channels (C_{P1}) and (C_{P2}) each composed of two sections of straight ducts connected end to end and deployed following a helical trajectory to the outputs (S_{P1}) and (S_{P2}). Thus, when the annular jet (J_{AP}) penetrates the said rotor (R_{P}) through the input (E_{P}), it is divided into two distinct jets that flow to the outputs (S_{P1}) and (S_{P2}). A mechanical torque with respect to the axis (Z_{P}) is generated by the fluid flow through the channels driving the spinning top (T_{P}) in rotation.

As a non-limiting example, a channel (C_{PQ}) can be: (i) composed of several sections of straight ducts connected end to end and deployed following a helical trajectory, [FIG. 17] and [FIG. 18], (ii) a helix or spiral, [FIG. 15], [FIG. 16] and [FIG. 19], (iii) convergent or divergent and of circular or non-circular cross-section. In another example of rotor realization (R_{P}), the channels (C_{PQ}) can be replaced by blades or blades.

The performance of the device according to the invention depends on the speed of rotation (P) of the spinning tops (T_{P}). This rotational speed influences the interaction time of the orbital jets (JO_{PQ}) with the surface to be treated. Thus, a very high rotational speed (P) does not give the jet enough time to work the target surface. Conversely, a very low rotational speed (P) would reduce the treated area per unit of time. Therefore, given the importance of the rotational speed (P), the device according to the invention may be equipped with a system for regulating the rotational speed of the spinning tops (T_{P}), in the form of a mechanical, hydraulic, magnetic brake, etc.

During its flow in the channels (C_{PQ}), the jet may undergo several deviations causing strong eddies and consequently significant pressure and coherence losses. In order to reduce if not eliminate these eddies if they occur, different solutions are possible: (i) provide non-circular sections of channels (C_{PQ}) over all or part of their length, such as a square, triangular, hexagonal or other section, (ii) integrer to the channels (C_{PQ}) of the flow rectifiers.

Referring to FIGS. 20 and 21, a further embodiment of the device of the invention is described, in which the rotor 1 is substantially the same as described previously, but the device comprises a different type of mounting for the rotor. Referring initially to FIG. 20, the device comprises a housing 2 including an upper housing 3 that serves as a pressure chamber with a fluid inlet and a lower housing 4 with an open end 5. The upper housing 3 is separated from the lower housing 4 by a dividing wall 6 with a liquid outlet 7. The rotor 1 comprises an axle 10 with a ball 11 mounted co-axially on an upper end of the axle. The upper housing 3 comprises a mounting in the form of a support arm 12 that projects laterally across the upper housing and comprises a socket 13 with a central aperture 14. The socket 13 and liquid outlet 7 are aligned along a common axis 15. The axle 10 of the rotor 1 projects through the liquid outlet 7 and the ball 11 nests in the socket 13, supporting and suspending the rotor from the mounting for rotation about the axis 15.

The socket 13 comprises a frustoconical depression and comprises a roller bearing 20 to reduce friction when the ball 11 rotates in the socket. It will be appreciated that the socket can have different shapes, so long as it supports the ball and allows the ball to rotate freely. When assembled, the ball, axle and rotor are suspended along the axis 15.

In use, a fluid (in this embodiment, a liquid) is provided to the upper housing 3 via the fluid inlet under pressure, where the pressure in the housing causes the liquid to pass in a jet through the liquid outlet 7 around the axle 10 and into an inlet of the the helical conduit of the rotor (not shown, but described previously). This causes the rotor 1 to rotate relative to the mounting to produce a jet of atomised water droplets that exit the device through the open end 5 of the lower housing 4. The provision of the mounting in the form of a ball and socket type bearing arrangement is an efficient method of mounting the rotor for rotation in a wet environment resulting in reduced wear and tear compared with the bearing arrangement of FR2934508 A1.

Referring to FIG. 21, an alternative embodiment of the device of the invention is described in which pats described previously with reference to FIG. 20 are assigned the same reference numerals. In this embodiment, which is substantially the same as the embodiment of FIG. 20, the upper housing comprises an axle guide 22 comprising an arm 23 that projects laterally into the upper housing 3 having a bore 24 dimensioned to receive the axle 10. The bore is slightly wider than a width of the axle to provide clearance for rotation of the axle in the bore while providing sufficient clearance around the axle to allow a normal degree of vibration during operation. The axle guide serves to maintain the axle in a position along the axis of rotation of the rotor.

The device according to the invention is particularly intended for projecting fluid jets loaded or not with particles to carry out operations such as sandblasting, stripping, polishing, shot blasting, washing-cleaning, scrub, massage, drying, watering, painting, atomizing, etc.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A device (1) for delivering an orbital fluid jet, comprising:
a body comprising a pressure chamber (3) provided with a fluid inlet and a fluid outlet (7);
a rotor (1) having a top, a bottom, a rotational axis (15), and a fluid channel (CPQ) having a fluid inlet (EP) located on the top of the rotor on the axis (15) for receipt of fluid from the fluid outlet (7) of the body, an outlet (SPQ) located on the bottom of the rotor (1) spaced from the axis (15), and a helical channel providing fluid communication between the inlet and exit configured to cause the rotor to rotate about the axis (15) when fluid is forced through the channel; and
a mounting for rotatably mounting the rotor (1),
wherein the mounting is disposed within the pressure chamber (3), and the rotor (1) comprises an axle (10) that extends into the pressure chamber (3) through the fluid outlet (7), wherein the axle is suspended from the mounting for rotation relative to the mounting about the rotational axis (15).

2. The device (1) according to claim 1, in which the mounting comprises a socket (13) with a central aperture (14), and in which the axle (10) extends through the central aperture and comprises a ball (11) configured to nest in the socket (13) for rotation of the ball and axle relative to the socket.

3. The device according to claim 2, in which the ball (11) is spherical or hemi-spherical.

4. The device according to claim 1, in which a bearing surface of the mounting comprises a ball or roller bearing.

5. The device according to claim 1, including an axle guide (22) disposed in the pressure chamber (3) between the mounting and the fluid outlet (7).

6. The device according to claim 1, in which the helical channel comprises a plurality of sections of straight channel sections connected end to end and deployed in a helical path.

7. The device according to claim 1, in which the helical channel tapers inwardly or outwardly from the inlet to the outlet.

8. The device according to claim 1, in which the rotor (RP) comprises a plurality of channels each having a shared inlet (EP) and upper section and separate diverging lower sections (SP1, SP2 . . . ).

9. The device according to claim 1, in which the or each channel outlet (SPQ) is located at a periphery of the bottom of the rotor (RP).

10. The device according to claim 1, including a handle (1) having a distal end and a through lumen, wherein the distal end of the handle is coupled to the body (K) and the lumen is fluidically coupled to the pressure chamber (CH).

11. The device according to claim 1, in which the rotor has a frustoconical shape.
